(19) United States
(12) Patent Application Publication
(10) Pub. No.: US 2006/0190640 A1
(43) Pub. Date: Aug. 24, 2006

(54) Data transfer system and data transfer method

(75) Inventors: Hitoshi Yoda, Kawasaki (JP); Hiroyuki Utsumi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/168,348

(22) Filed: Jun. 29, 2005

(30) Foreign Application Priority Data
Feb. 16, 2005 (JP) 2005-039749

(51) Int. Cl. G06F 5/00

(52) U.S. Cl. 710/52

(57) ABSTRACT

A buffer memory temporarily stores data sequentially outputted to a data using apparatus. A memory is accessed by at least one memory access circuit via a bus. A data transfer circuit performs a data transfer from the memory to the buffer memory via the bus. The data transfer circuit performs the data transfer from the memory to the buffer memory under a state where the bus is occupied by the data transfer circuit from when an amount of data in the buffer memory is less than a first predetermined amount to when the amount of data in the buffer memory exceeds a second predetermined amount larger than the first predetermined amount.

### CROSS-REFERENCE TO RELATED APPLICATIONS

This application is based upon and claims the benefit of priority from Japanese Patent Application No. 2005-039749, filed on Feb. 16, 2005, the entire contents of which are incorporated herein by reference.

### BACKGROUND OF THE INVENTION

1. Field of the Invention

The present invention relates to a data transfer system and a data transfer method, and more particularly, to a technique for securing normality of an image display function or an image capture function in various systems.

2. Description of the Related Art

In a system having an image display function, when an image display apparatus initiates an image display operation, an image display controller requests a DMA controller to transfer image data from a memory (such as SDRAM), in which the image data is stored, to a buffer memory (FIFO memory). In response to the DMA transfer request from the image display controller, the DMA controller transfers the image data from the memory to the FIFO memory via a bus. As the image display controller sequentially outputs the image data stored in the FIFO memory to the image display apparatus, images are displayed on the image display apparatus. In addition, the image display controller suspends the DMA transfer request when a vacant area does not exist in the FIFO memory any longer while the image display apparatus performs the image display, and restarts the DMA transfer request when a new vacant area occurs in the FIFO memory.

On the other hand, in a system having an image capture function, when an image capture operation is initiated, an image capture controller stores image data sequentially inputted therein in a FIFO memory and requests a DMA controller to transfer the image data from the FIFO memory to a memory in which the image data is stored. In response to the DMA transfer request from the image capture controller, the DMA controller transfers the image data from the FIFO memory to the memory via a bus. In addition, the image capture controller suspends the DMA transfer request when there is no more image data stored in the FIFO memory while the image capture operation is performed, and restarts the DMA transfer request when new image data is stored in the FIFO memory.

In addition, Japanese Unexamined Patent Application Publication No. 2001-184301 discloses a technique for implementing an image data transfer without complete occupation of a bus in an image data transfer system including a host device, an image memory in which image data generated by the host device is stored, and an output interface unit for transferring the image data read from the image memory to an output device, all of which are interconnected via the bus. In more detail, a FIFO memory is provided as an image buffer memory in the output interface unit, the FIFO memory reports accumulated information of the image data to a bus arbitration circuit. Based on the contents of the report from the FIFO memory, the bus arbitration circuit changes the priority concerning the bus use of a data transfer processing circuit provided in a device to become a bus master. For example, when the almost full flag of the FIFO memory is established, the bus arbitration circuit prompts the stop of image data write into the FIFO memory by lowering the priority of image data transfer, and, when the almost empty flag of the FIFO memory is established, the bus arbitration circuit prompts the write of image data into the FIFO memory by raising the priority of image data transfer.

In the system having the image display function, if there exists a plurality (for example, three) of bus masters (including a DMA controller) accessing a memory via a bus and the access to the memory concurs between the plurality of bus masters, the access to the memory is sequentially made with uniform frequency for the bus masters. When the access to the memory concurs between the plurality of bus masters while the image display apparatus performs the image display operation, since access of the DMA controller to the memory is made only one time while the access of the bus master to the memory is made three times, a throughput (the amount of data transfer in the unit time) between the memory and the FIFO memory is reduced to about ⅓ of a throughput obtainable when the access to the memory does not concur between the plurality of bus masters. In addition, since the memory accessed by the plurality of bus masters typically has access regions, each of which is assigned for each bus master, a page miss may occur when the bus master accessing the memory is replaced by another bus master, further reducing the throughput between the memory and the FIFO memory.

When a size of an image displayed by the image display apparatus is small, since a required throughput between the memory and FIFO memory is low, there is little effect on the reduction of the throughput on the image display function. However, with the recent trend to increase the size of an image, a higher throughput is required between the memory and the FIFO memory. Accordingly, if the throughput between the memory and the FIFO memory is reduced because the data transfer from the memory to the FIFO memory cannot be performed stably, the write of the image data into the FIFO memory for the image display of the image display apparatus (i.e., output of the image data to the image display apparatus) is not sufficient, causing interruption of continuous images such as moving images so that the image display cannot be performed normally. Such a problem is true of the image capture function. If the access to the memory concurs between the bus masters while the image capture operation is performed, the data transfer from the FIFO memory to the memory cannot be performed stably, and accordingly, read of the image data from the FIFO memory for the image capture is insufficient. As a result, the FIFO memory overflows so that the image capture cannot be performed normally.

In addition, in the technique disclosed in Japanese Unexamined Patent Application Publication No. 2001-184301, even when the data transfer is not requested from other devices to become the bus master, since the image data transfer from the image memory to the FIFO memory is not performed until the almost empty flag of the FIFO memory is established after the almost full flag is established, the throughput between the image memory and the FIFO memory is uselessly reduced. In addition, since the amount of image data transfer at a time is almost equal to the capacity of the FIFO memory, and therefore, time required for the image data transfer at a time is very long, other devices to become the bus master are forced to stop for a long time, lowering the use efficiency of the bus (responsibility of the bus).

### SUMMARY OF THE INVENTION

It is an object of the present invention to secure normality of a system function (image display function or image capture function) by improving a throughput between a memory and a buffer memory without lowering use efficiency of a bus.

In a first aspect of the present invention, data sequentially outputted to a data using apparatus is temporarily stored in a buffer memory. For example, the data using apparatus is an image display apparatus and the data stored in the buffer memory is image data used for image display of the image display apparatus. A memory is accessed by at least one memory access circuit via a bus. A data transfer circuit performs a data transfer from the memory to the buffer memory via the bus. The data transfer circuit performs the data transfer from the memory to the buffer memory under a state where the bus is occupied by the data transfer circuit from when the amount of data in the buffer memory is less than a first predetermined amount to when the amount of data in the buffer memory exceeds a second predetermined amount larger than the first predetermined amount.

Accordingly, from when the amount of data in the buffer memory is less than the first predetermined amount to when the amount of data in the buffer memory exceeds the second predetermined amount, the data transfer circuit can perform the data transfer (including the access to the memory) all the time without making the memory access circuit access the memory. As a result, since the throughput between the memory and the buffer memory is improved, it can be reliably prevented that the write of image data into the buffer memory for image display of the image display apparatus is insufficient. Accordingly, abnormality of the image display function, such as interruption of continuous images, can be reliably prevented. In addition, even if access regions in the memory are assigned for each accessing circuit (the memory access circuit and the data transfer circuit), no page miss occurs from when the amount of data in the buffer memory is less than the first predetermined amount to when the amount of data in the buffer memory exceeds the second predetermined amount, and accordingly, reduction of the throughput between the memory and the buffer memory due to the page miss can be avoided.

In addition, even after the amount of data in the buffer memory exceeds the second predetermined amount, if there is no access request of the memory access circuit to the memory, or if the priority of the access of the data transfer circuit to the memory is higher than that of the access of the memory access circuit to the memory even though the former concurs with the latter, since the data transfer from the memory to the buffer memory is performed, reduction of the throughput between the memory and the buffer memory can be avoided. In addition, for example, by setting a difference between the first predetermined amount and the second predetermined amount to a minimal amount to guarantee the normality of the image display function, time during which the data transfer circuit occupies the bus is suppressed to a minimum required, and accordingly, use efficiency of the bus can be prevented from being reduced.

In a preferable example of the first aspect of the present invention, an arbitration circuit arbitrates an access request from the memory access circuit and an access request from the data transfer circuit to grant access to the memory to one of the memory access circuit and the data transfer circuit. A vacancy controller activates an emergency signal when the amount of data in the buffer memory is less than the first predetermined amount and deactivates the emergency signal when the amount of data in the buffer memory exceeds the second predetermined amount. The arbitration circuit keeps granting the access to the memory to the data transfer circuit during the emergency signal is activated, regardless of the access request from the memory access circuit. With this configuration, the normality of the image display function can be easily secured by the improvement of the throughput.

In a second aspect of the present invention, data sequentially captured from a data supply apparatus is temporarily stored in a buffer memory. For example, the data supply apparatus is an image supply apparatus supplying image data sequentially. A memory is accessed by at least one memory access circuit via a bus. A data transfer circuit performs a data transfer from the buffer memory to the memory via the bus. The data transfer circuit performs the data transfer under a state where the bus is occupied by the data transfer circuit, from when the amount of data in the buffer memory exceeds a first predetermined amount to when the amount of data in the buffer memory is less than a second predetermined amount smaller than the first predetermined amount.

Accordingly, from when the amount of data in the buffer memory exceeds the first predetermined amount to when the amount of data in the buffer memory is less than the second predetermined amount, the data transfer circuit can perform the data transfer (including the access to the memory) all the time without making the memory access circuit access the memory. As a result, since the throughput between the memory and the buffer memory is improved, it can be reliably prevented that the read of image data from the buffer memory for image capture is insufficient. Accordingly, abnormality of the image capture due to overflow of the buffer memory can be reliably prevented. In addition, even if access regions in the memory are assigned for each accessing circuit (the memory access circuit and the data transfer circuit), no page miss occurs from when the amount of data in the buffer memory exceeds the first predetermined amount to when the amount of data in the buffer memory is less than the second predetermined amount, and accordingly, reduction of the throughput between the memory and the buffer memory due to the page miss can be avoided.

In addition, even after the amount of data in the buffer memory is less than the second predetermined amount, if there is no access request of the memory access circuit to the memory, or if the priority of the access of the data transfer circuit to the memory is higher than that of the access of the memory access circuit to the memory even though the former concurs with the latter, since the data transfer from the buffer memory to the memory is performed, reduction of the throughput between the memory and the buffer memory can be avoided. In addition, for example, by setting a difference between the first predetermined amount and the second predetermined amount to a minimal amount to guarantee the normality of the image capture function, period during which the data transfer circuit occupies the bus is suppressed to a minimum required, and accordingly, use efficiency of the bus can be prevented from being reduced.

In a preferable example of the second aspect of the present invention, an arbitration circuit arbitrates an access request from the memory access circuit and an access request from the data transfer circuit to grant access to the memory to one of the memory access circuit and the data transfer circuit. A vacancy controller activates an emergency signal when the amount of data in the buffer memory exceeds the first predetermined amount and deactivates the emergency signal when the amount of data in the buffer memory is less than the second predetermined amount. The arbitration circuit keeps granting the access to the memory to the data transfer circuit during the emergency signal is activated, regardless of the access request from the memory access circuit. With this configuration, the normality of the image capture function can be easily secured by the improvement of the throughput.

In a preferable example of the first or second aspect of the present invention, there is provided at least one of a first register specifying the first predetermined amount by a register value and a second register specifying the second predetermined amount by a register value. Accordingly, at least one of the first and second predetermined amounts can be varied. Thus, since at least one of a start timing and an end timing of bus occupation of the data transfer circuit can be changed, the present invention can properly cope with various systems.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram illustrating a first embodiment of the present invention;

FIG. 2 is an explanatory diagram illustrating an outline of operation of an image display controller shown in FIG. 1;

FIG. 3 is an explanatory diagram illustrating an outline of a data flow in the first embodiment;

FIG. 4 is a block diagram illustrating a comparative example of the present invention;

FIG. 5 is an explanatory diagram illustrating an outline of a data flow in the comparative example of the present invention;

FIG. 6 is an explanatory diagram illustrating an outline of a data flow in the comparative example of the present invention;

FIG. 7 is a block diagram illustrating a second embodiment of the present invention; and

FIG. 8 is an explanatory diagram illustrating an outline of operation of an image capture controller shown in FIG. 7.

### DESCRIPTION OF THE PREFERRED EMBODIMENTS

Hereinafter, preferred embodiments of the present invention will be described with reference to the accompanying drawings.

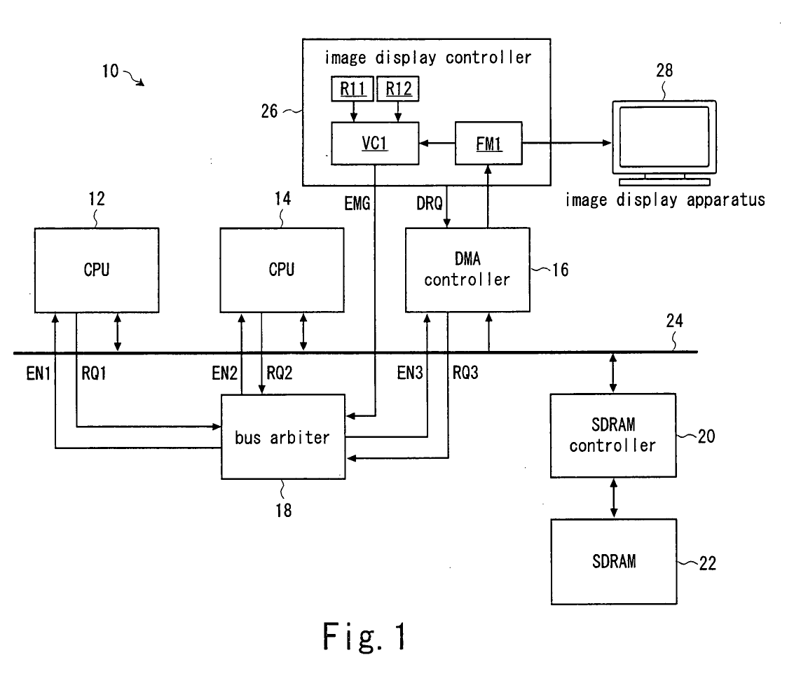

FIG. 1 is a block diagram illustrating a first embodiment of the present invention. A system 10 having an image display function includes CPUs 12 and 14 (memory access circuits), a DMA controller 16 (data transfer circuit), a bus arbiter 18 (arbitration circuit), a SDRAM controller 20, a SDRAM 22 (memory), a bus 24, an image display controller 26, and an image display apparatus 28 (data using apparatus).

The CUPs 12 and 14 are bus masters connected to the bus 24 for performing an audio process or various instructions. The CPU 12 activates a bus use request signal RQ1 to the bus arbiter 18 when the bus 24 is used, and accesses (i.e., writes/reads data into/from) the SDRAM 22 through the bus 24 and the SDRAM controller 20 upon recognizing capture of bus right by activation of a bus use permission signal EN1 from the bus arbiter 18. The CPU 14 activates a bus use request signal RQ2 to the bus arbiter 18 when the bus 24 is used, and accesses the SDRAM 22 through the bus 24 and the SDRAM controller 20 upon recognizing capture of bus right by activation of a bus use permission signal EN2 from the bus arbiter 18.

The DMA controller 16 is a bus master connected to the bus 24 and activates a bus use request signal RQ3 to the bus arbiter 18 in response to activation of a DMA transfer request signal DRQ from the image display controller 26, and transfers the image data from the SDRAM 22 to a FIFO memory FM1 (buffer memory) within the image display controller 26 through the bus 24 and the SDRAM controller 20 upon recognizing capture of bus right by activation of a bus use permission signal EN3 from the bus arbiter 18.

In response to the bus use request signals RQ1 to RQ3 from the CPUs 12 and 14 and the DMA controller 16, the bus arbiter 18 grants the bus right of the bus 24 to one of the CPUs 12 and 14 and the DMA controller 16 by activating one of the bus use permission signals EN1 to EN3 during deactivation of an emergency signal EMG from the image display controller 26. The bus arbiter 18 keeps granting the bus right to the DMA controller 16 by activating the bus use permission signal EN3 during activation of the emergency signal EMG from the image display controller 26, regardless of the bus use request signals RQ1 and RQ2 from the CPUs 12 and 14. That is, access of the CPUs 12 and 14 to the SDRAM 22 is inhibited during the activation of the emergency signal EMG from the image display controller 26.

The SDRAM controller 20 acts as an interface circuit allowing the CPUs 12 and 14 and the DMA controller 16 to access the SDRAM 22. The SDRAM 22 is connected to the bus 24 via the SDRAM controller 20 and is accessed by the CPUs 12 and 14 and the DMA controller 16. The bus 24 interconnects the CPUs 12 and 14, the DMA controller 16, and the SDRAM controller 20 (SDRAM 22), allowing data exchange therebetween.

The image display controller 26 includes the FIFO memory FM1 in which the image data to be provided to the image display apparatus 28 is temporarily stored, a first register R11, a second register R12, and a vacancy controller VC1. The vacancy controller VC1 activates the emergency signal EMG when the amount of data of the FIFO memory FM1 is less than the amount of data indicated by a register value of the register R11 (first predetermined amount). The vacancy controller VC1 deactivates the emergency signal EMG when the amount of data of the FIFO memory FM1 exceeds the amount of data indicated by a register value of the register R12 (second predetermined amount).

The registers R11 and R12 can set register values via a bus (not shown) different from the bus 24, for example. The register values of the registers R11 and R12 are preset such that the second predetermined amount becomes larger than the first predetermined amount. During output of the image data to the image display apparatus 28 (i.e., image display operation of the image display apparatus 28), the image display controller 26 activates the DMA transfer request signal DRQ to the DMA controller 16 if there is any vacant area in the FIFO memory FM1, and deactivates the DMA transfer request signal DRQ to the DMA controller 16 if there is no vacant area in the FIFO memory FM1. The image display apparatus 28 performs the image display operation using the image data sequentially outputted from the image display controller 26.

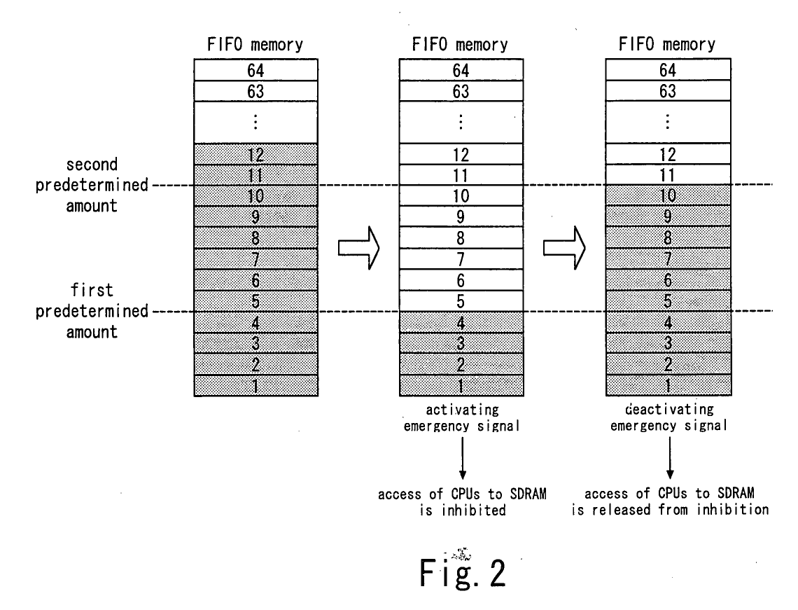

FIG. 2 illustrates an outline of operation of the image display controller 26 shown in FIG. 1. In this example, the FIFO memory FM1 has a 64-stack configuration. The first predetermined amount (the amount of data indicated by the register value of the register R11) is the amount of data corresponding to four stacks of the FIFO memory FM1. The second predetermined amount (the amount of data indicated by the register value of the register R12) is the amount of data corresponding to ten stacks of the FIFO memory FM1.

During the image display of the image display apparatus 28, when the access of the DMA controller 16 to the SDRAM 22 concurs with the access of the CPUs 12 and 14 to the SDRAM 22, for example, under a condition that the amount of data of the FIFO memory FM1 is the amount of data corresponding to 12 stacks, the amount of data of the FIFO memory FM1 begins to decrease if the amount of image data DMA-transferred from the SDRAM 22 to the FIFO memory FM1 is less than the amount of image data outputted from the FIFO memory FM1 to the image display apparatus 28.

When the amount of data of the FIFO memory FM1 decreases to the amount of data corresponding to four stacks (the first predetermined amount), the vacancy controller VC1 activates the emergency signal EMG. Accordingly, the access of the CPUs 12 and 14 to the SDRAM 22 is inhibited and the access of the DMA controller 16 to the SDRAM 22 (the data transfer from the SDRAM 22 to the FIFO memory FM1) is made under a state where the bus 24 is occupied. Thus, the amount of image data DMA-transferred from the SDRAM 22 to the FIFO memory FM1 becomes larger than the amount of image data outputted from the FIFO memory FM1 to the image display apparatus 28, and accordingly, the amount of data of the FIFO memory FM1 begins to increase. When the amount of data of the FIFO memory FM1 increases to the amount of data corresponding to ten stacks (the second predetermined amount), the vacancy controller VC1 deactivates the emergency signal EMG. Accordingly, the access of the CPUs 12 and 14 to the SDRAM 22 is released from the inhibition.

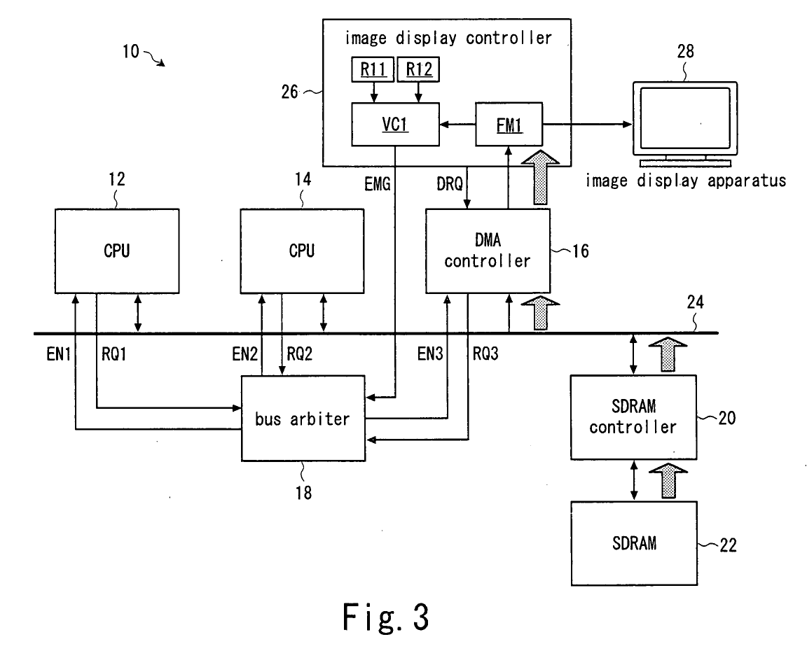

FIG. 3 illustrates an outline of a data flow in the first embodiment. Thickness of netted arrows in the figure corresponds to the throughput. This example corresponds to a data flow during activation of the emergency signal EMG. During the activation of the emergency signal EMG (i.e., during a period of time until the amount of data of the FIFO memory FM1 exceeds the second predetermined amount after it is less than the first predetermined amount), since the access of the CPUs 12 and 14 to the SDRAM 22 is inhibited, it is possible to make the throughput between the SDRAM 22 and the bus 24 equal to the throughput between the FIFO memory FM1 and the bus 24. That is, the throughput between the SDRAM 22 and the buffer memory FM1 is improved. Accordingly, it can be reliably prevented that the write of the image data into the FIFO memory FM1 for the image display of the image display apparatus 28 is insufficient.

In addition, even after the amount of data of the FIFO memory FM1 exceeds the second predetermined amount, if there is no access of the CPUs 12 and 14 to the SDRAM 22, or if the priority of the access of the DMA controller 16 to the SDRAM 22 is higher than that of the access of the CPUs 12 and 14 to the SDRAM 22 even though the former concurs with the latter, since the image data transfer from the SDRAM 22 to the FIFO memory FM1 is performed, reduction of the throughput between the SDRAM 22 and the FIFO memory FM1 is suppressed.

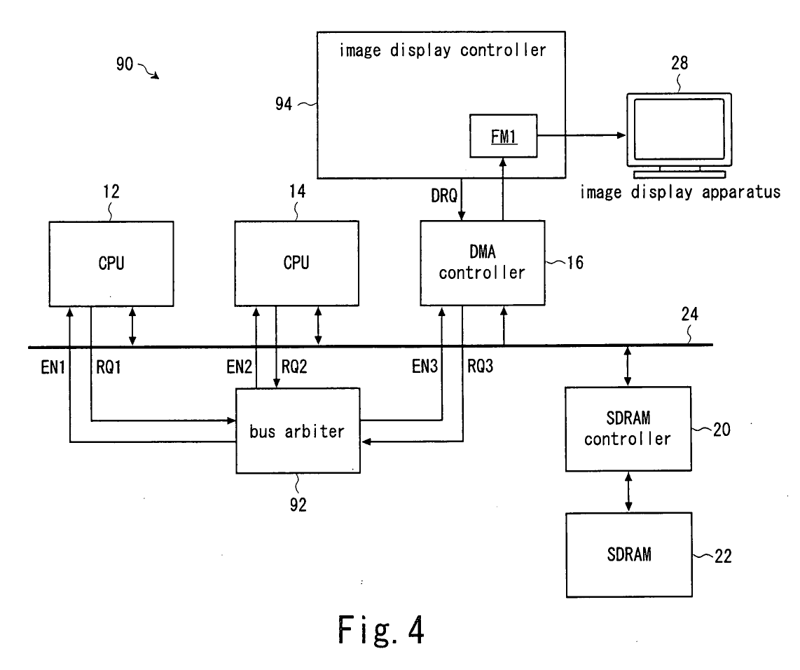

FIG. 4 illustrates a comparative example of the present invention. In the following description of the comparative example of the present invention, the same elements as those described in the first embodiment (FIG. 1) are denoted by the same reference numerals, and detailed explanation thereof will be omitted. A system 90 of the comparative example of the present invention includes a bus arbiter 92 and an image display controller 94, instead of the bus arbiter 94 and the image display controller 26 in the first embodiment. Except this configuration, the system 90 is the same configuration as the system 10 of the first embodiment. The operation of the bus arbiter 92 is equal to the operation during the deactivation of the emergency signal EMG in the bus arbiter 18 of the first embodiment. The image display controller 94 has a configuration where the registers R11 and R12 and the vacancy controller VC1 are removed from the image display controller 26 of the first embodiment.

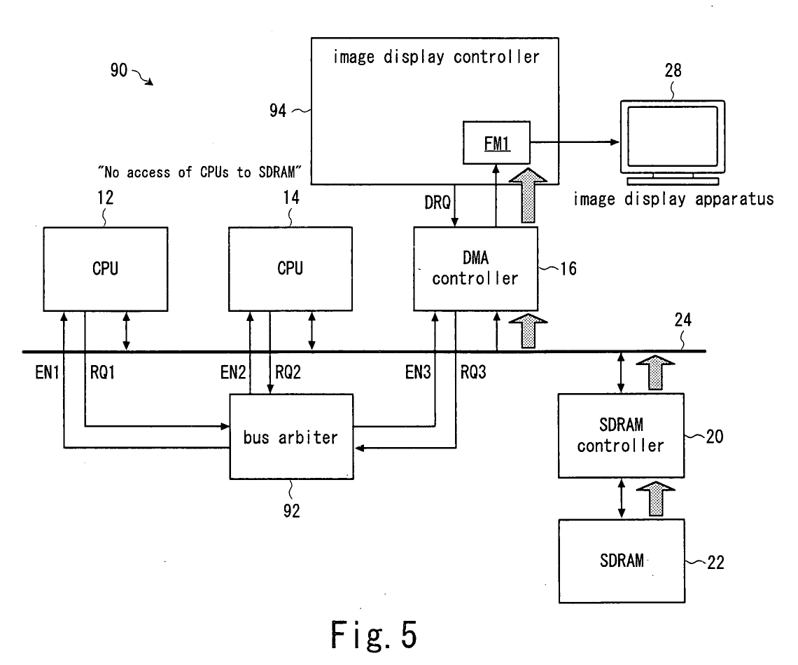

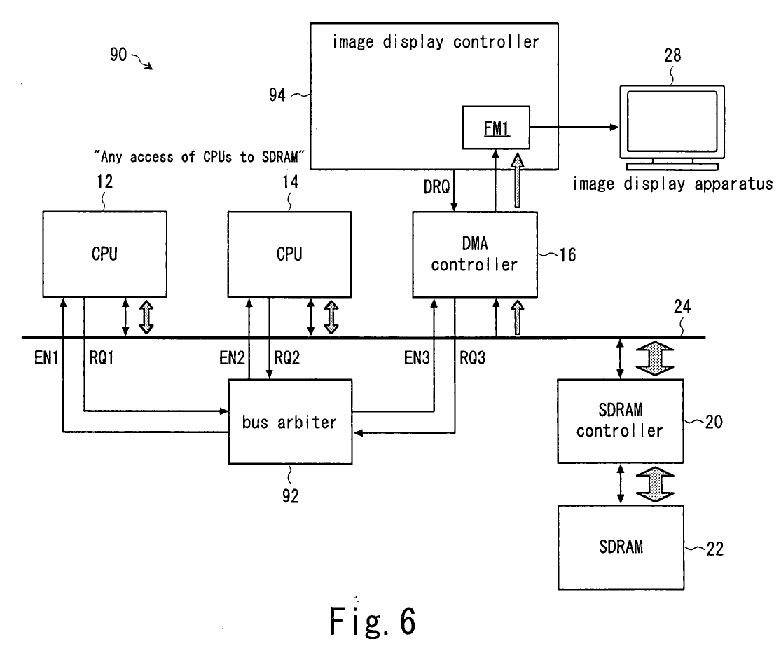

FIGS. 5 and 6 illustrate outlines of data flows in the comparative example of the present invention. FIG. 5 corresponds to a data flow when the access of the CPUs 12 and 14 to the SDRAM 22 does not concur with the access of the DMA controller 16 to the SDRAM 22. FIG. 6 corresponds to a data flow when the access of the CPUs 12 and 14 to the SDRAM 22 concurs with the access of the DMA controller 16 to the SDRAM 22. Similarly in FIG. 3, thickness of netted arrows in FIGS. 5 and 6 corresponds to the throughput.

When the access of the CPUs 12 and 14 to the SDRAM 22 does not concur with the access of the DMA controller 16 to the SDRAM 22, the throughput between the SDRAM 22 and the bus 24 is equal to the throughput between the FIFO memory FM1 and the bus 24, as shown in FIG. 5. Accordingly, no insufficient write of the image data into the buffer memory FM1 for the image display of the image display apparatus 28 occurs.

On the contrary, when the access of the CPUs 12 and 14 to the SDRAM 22 concurs with the access of the DMA controller 16 to the SDRAM 22, since the accesses to the SDRAM 22 are sequentially made with uniform frequency for both of the CPUs 12 and 14 and the DMA controller 16, the access of the DMA controller 16 to the SDRAM 22 is made only one time while the access to the SDRAM 22 is made three times. Accordingly, as shown in FIG. 6, the throughput between the FIFO memory FM1 and the bus 24 is reduced to about ⅓ of the throughput obtainable in FIG. 5. As a result, the write of the image data into the FIFO memory FM1 for the image display of the image display apparatus 28 is not sufficient, causing interruption of continuous images so that the image display cannot be normally performed. In addition, if access regions in the SDRAM 22 are assigned for each bus master (the CPUs 12 and 14 and the DMA controller 16), a page miss may occur when a bus master is replaced by another bus master, further reducing the throughput between the SDRAM 22 and the FIFO memory FM1.

As can be seen from the above description, in the first embodiment, during the activation of the emergency signal EMG from the image display controller 26, the DMA controller 16 can perform the image data transfer all the time without making the CPUs 12 and 14 access the SDRAM 22. As a result, since the throughput between the SDRAM 22 and the FIFO memory FM1 is improved, it can be reliably prevented that the write of the image data into the FIFO memory FM1 for the image display of the image display apparatus 28 is insufficient. Accordingly, abnormality of the image display, for example, interruption of continuous images such as moving images, can be reliably prevented. In addition, even if access regions in the SDRAM 22 are assigned for each bus master (the CPUs 12 and 14 and the DMA controller 16), no page miss occurs during the activation of the emergency signal EMG, and accordingly, reduction of the throughput between the SDRAM 22 and the FIFO memory FM1 due to the page miss can be avoided.

In addition, even after the emergency signal EMG is deactivated, if there is no access of the CPUs 12 and 14 to the SDRAM 22, or if the priority of the access of the DMA controller 16 to the SDRAM 22 is higher than that of the access of the CPUs 12 and 14 to the SDRAM 22 even though the former concurs with the latter, since the image data transfer from the SDRAM 22 to the FIFO memory FM1 is performed, reduction of the throughput between the SDRAM 22 and the FIFO memory FM1 can be avoided. In addition, since a start timing and an end timing of the bus occupation of the DMA controller 16 can be changed by changing the register values of the registers R11 and R12, the present invention can properly cope with various systems. For example, by setting the register values of the registers R11 and R12 such that a difference between the first predetermined amount and the second predetermined amount is minimized to guarantee the normality of the image display function, time during which the DMA controller 16 occupies the bus can be suppressed to a minimum required, thereby improving use efficiency of the bus 24.

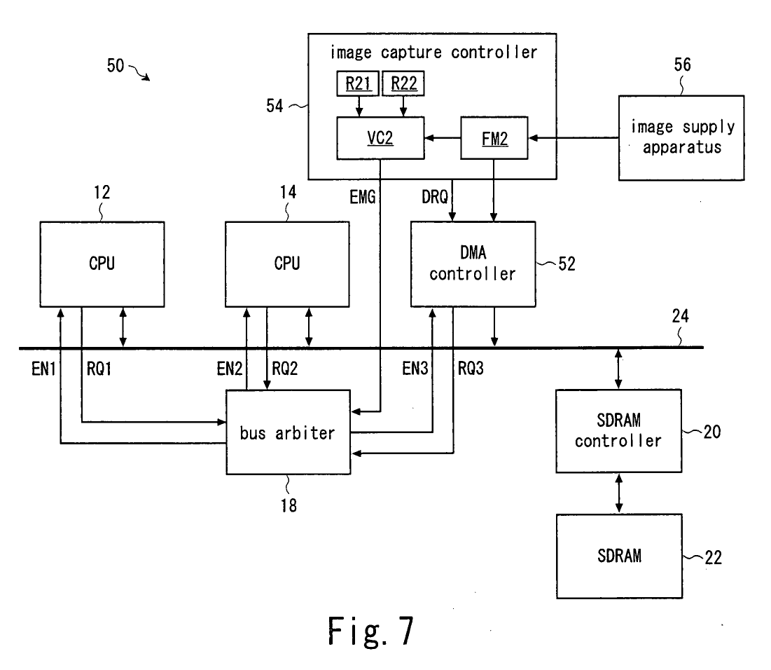

FIG. 7 illustrates a second embodiment of the present invention. In the following description of the second embodiment, the same elements as those described in the first embodiment (FIG. 1) are denoted by the same reference numerals, and detailed explanation thereof will be omitted. A system 50 having an image capture function includes CPUs 12 and 14 (memory access circuits), a DMA controller 52 (data transfer circuit), a bus arbiter 18 (arbitration circuit), a SDRAM controller 20, SDRAM 22 (memory), a bus 24, an image capture controller 54, and an image supply apparatus 56 (data supply apparatus).

The DMA controller 52 is a bus master connected to the bus 24 and activates the bus use request signal RQ3 to the bus arbiter 18 in response to activation of the DMA transfer request signal DRQ from the image capture controller 54, and transfers the image data from a FIFO memory FM2 (buffer memory) within the image capture controller 54 to the SDRAM 22 through the bus 24 and the SDRAM controller 20 upon recognizing capture of bus right by activation of the bus use permission signal EN3 from the bus arbiter 18.

The image capture controller 54 includes the FIFO memory FM2 in which the image data sequentially provided from the image supply apparatus 56 is temporarily stored, a first register R21, a second register R22, and a vacancy controller VC2. The vacancy controller VC2 activates the emergency signal EMG when the amount of data of the FIFO memory FM2 exceeds the amount of data indicated by a register value of the register R21 (first predetermined amount). The vacancy controller VC2 deactivates the emergency signal EMG when the amount of data of the FIFO memory FM2 is less than the amount of data indicated by a register value of the register R22 (second predetermined amount).

The registers R21 and R22 can set register values via a bus (not shown) different from the bus 24, for example. The register values of the registers R21 and R22 are preset such that the second predetermined amount becomes smaller than the first predetermined amount. During input of the image data from the image supply apparatus 56 (i.e., image capture operation), the image capture controller 54 activates the DMA transfer request signal DRQ to the DMA controller 52 if the image data is stored in the FIFO memory FM2, and deactivates the DMA transfer request signal DRQ to the DMA controller 52 if the image data is not stored in the FIFO memory FM2. The image supply apparatus 56 supplies the image data to the image capture controller 54 sequentially.

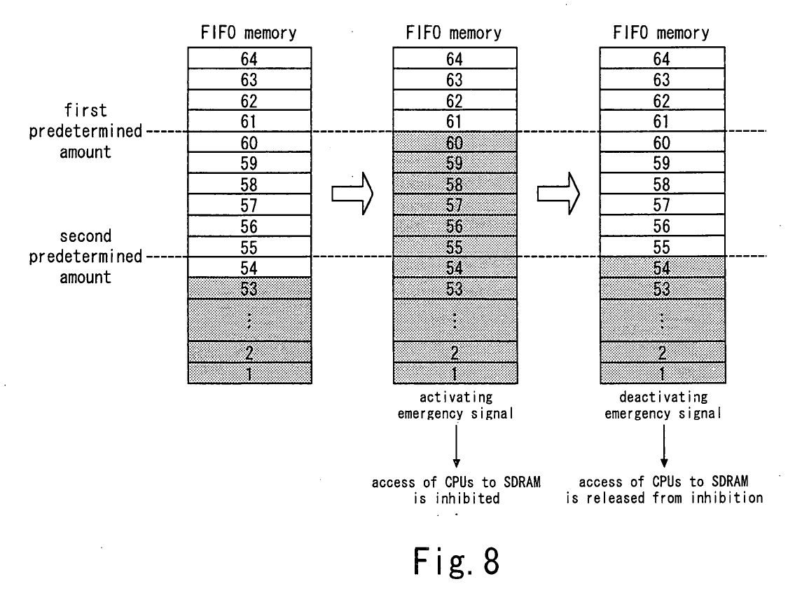

FIG. 8 illustrates an outline of operation of the image capture controller 54 shown in FIG. 7. In this example, the FIFO memory FM2 has a 64-stack configuration. The first predetermined amount (the amount of data indicated by the register value of the register R21) is the amount of data corresponding to 60 stacks of the FIFO memory FM2. The second predetermined amount (the amount of data indicated by the register value of the register R22) is the amount of data corresponding to 54 stacks of the FIFO memory FM2.

During the image capture operation, when the access of the DMA controller 52 to the SDRAM 22 concurs with the access of the CPUs 12 and 14 to the SDRAM 22 under a condition that the amount of data of the FIFO memory FM1 is the amount of data corresponding to 53 stacks, the amount of data of the FIFO memory FM2 begins to increase if the amount of image data DMA-transferred from the FIFO memory FM2 to the SDRAM 22 is less than the amount of image data stored in the FIFO memory FM2 by the image capture.

When the amount of data of the FIFO memory FM2 increases to the amount of data corresponding to 60 stacks (the first predetermined amount), the vacancy controller VC2 activates the emergency signal EMG. Accordingly, the access of the CPUs 12 and 14 to the SDRAM 22 is inhibited and the access of the DMA controller 52 to the SDRAM 22 (the data transfer from the FIFO memory FM2 to the SDRAM 22) is made under a state where the bus 24 is occupied. Thus, the amount of image data DMA-transferred from the FIFO memory FM2 to the SDRAM 22 becomes larger than the amount of image data stored in the FIFO memory FM1 by the image capture, and accordingly, the amount of data of the FIFO memory FM2 begins to decrease. When the amount of data of the FIFO memory FM2 decreases to the amount of data corresponding to 54 stacks (the second predetermined amount), the vacancy controller VC2 deactivates the emergency signal EMG. Accordingly, the access of the CPUs 12 and 14 to the SDRAM 22 is released from the inhibition.

As can be seen from the above description, in the second embodiment, during the activation of the emergency signal EMG from the image capture controller 54, the DMA controller 52 can perform the image data transfer all the time without making the CPUs 12 and 14 access the SDRAM 22. As a result, since the throughput between the SDRAM 22 and the FIFO memory FM2 is improved, it can be reliably prevented that the read of the image data from the FIFO memory FM2 for the image capture is insufficient. Accordingly, abnormality of the image capture due to overflow of the FIFO memory FM2 can be reliably prevented. In addition, in a similar manner as in the first embodiment, even if access regions in the SDRAM 22 are assigned for each bus master (the CPUs 12 and 14 and the DMA controller 52), no page miss occurs during the activation of the emergency signal EMG, and accordingly, reduction of the throughput between the SDRAM 22 and the FIFO memory FM2 due to the page miss can be avoided.

In addition, even after the emergency signal EMG is deactivated, if there is no access of the CPUs 12 and 14 to the SDRAM 22, or if the priority of the access of the DMA controller 52 to the SDRAM 22 is higher than that of the access of the CPUs 12 and 14 to the SDRAM 22 even though the former concurs with the latter, since the image data transfer from the FIFO memory FM2 to the SDRAM 22 is performed, reduction of the throughput between the SDRAM 22 and the FIFO memory FM2 can be avoided. In addition, since a start timing and an end timing of bus occupation of the DMA controller 52 can be changed by changing the register values of the registers R21 and R22, the present invention can properly cope with various systems. For example, by setting the register value of the registers R21 and R22 such that a difference between the first predetermined amount and the second predetermined amount is minimized to guarantee the normality of the image capture function, time during which the DMA controller 52 occupies the bus can be suppressed to a minimum required, thereby improving use efficiency of the bus 24.

Although the first and second registers specifying an activation timing and a deactivation timing of the emergency signal EMG, respectively, has been illustrated in the first and second embodiments, the present invention is not limited to these embodiments. For example, if only a change of the deactivation timing of the emergency signal EMG is required, the first register may be removed with the first predetermined amount fixed, or if only a change of the activation timing of the emergency signal EMG is required, the second register may be removed with the second predetermined amount fixed. Alternatively, if changes of the deactivation and activation timings of the emergency signal EMG are not required, both of the first and second registers may be removed with both of the first and second predetermined amounts fixed. In these cases, since at least one of the first and second registers is unnecessary, a simple system configuration can be achieved and a system development term can be reduced.

In the above description, the invention is applied to transfer of image data in the first and second embodiments, but the invention is not limited to the embodiments. The invention may be applied to transfer of data (audio data) other than image data.

The invention is not limited to the above embodiments and various modifications may be made without departing from the spirit and scope of the invention. Any improvement may be made in part or all of the components.

What is claimed is:

1. A data transfer system comprising:
a buffer memory in which data sequentially outputted to a data using apparatus is temporarily stored;
a memory accessed by at least one memory access circuit via a bus; and
a data transfer circuit performing a data transfer from the memory to the buffer memory via the bus, wherein
the data transfer circuit performs the data transfer under a state where the bus is occupied by the data transfer circuit from when an amount of data in the buffer memory is less than a first predetermined amount to when the amount of data in the buffer memory exceeds a second predetermined amount larger than the first predetermined amount.

2. The data transfer system according to claim 1, further comprising:
an arbitration circuit arbitrating an access request from the memory access circuit and an access request from the data transfer circuit to grant access to the memory to one of the memory access circuit and the data transfer circuit; and
a vacancy controller activating an emergency signal when the amount of data in the buffer memory is less than the first predetermined amount and deactivating the emergency signal when the amount of data in the buffer memory exceeds the second predetermined amount, wherein
the arbitration circuit keeps granting the access to the memory to the data transfer circuit during the emergency signal is activated, regardless of the access request from the memory access circuit.

3. The data transfer system according to claim 1, further comprising:
at least one of a first register specifying the first predetermined amount by a register value and a second register specifying the second predetermined amount by a register value.

4. The data transfer system according to claim 1, wherein
the data using apparatus is an image display apparatus, and
the data stored in the buffer memory is image data used for image display of the image display apparatus.

5. A data transfer system comprising:
a buffer memory in which data sequentially captured from a data supply apparatus is temporarily stored;
a memory accessed by at least one memory access circuit via a bus; and
a data transfer circuit performing a data transfer from the buffer memory to the memory via the bus, wherein
the data transfer circuit performs the data transfer under a state where the bus is occupied by the data transfer circuit from when an amount of data in the buffer memory exceeds a first predetermined amount to when the amount of data in the buffer memory is less than a second predetermined amount smaller than the first predetermined amount.

6. The data transfer system according to claim 5, further comprising:
an arbitration circuit arbitrating an access request from the memory access circuit and an access request from the data transfer circuit to grant access to the memory to one of the memory access circuit and the data transfer circuit; and
a vacancy controller activating an emergency signal when the amount of data in the buffer memory exceeds the first predetermined amount and deactivating the emergency signal when the amount of data in the buffer memory is less than the second predetermined amount, wherein
the arbitration circuit keeps granting the access to the memory to the data transfer circuit during the emergency signal is activated, regardless of the access request from the memory access circuit.

7. The data transfer system according to claim 5, further comprising:
at least one of a first register specifying the first predetermined amount by a register value and a second register specifying the second predetermined amount by a register value.

8. The data transfer system according to claim 5, wherein
the data supply apparatus is an image supply apparatus supplying image data sequentially.

9. A data transfer method comprising the step of performing a data transfer via a bus from a memory accessed by at least one memory access circuit via the bus to a buffer memory in which data sequentially outputted to a data using apparatus is temporarily stored, wherein
the data transfer is performed under a state where the bus is occupied from when an amount of data in the buffer memory is less than a first predetermined amount to when the amount of data in the buffer memory exceeds a second predetermined amount larger than the first predetermined amount.

10. A data transfer method comprising the step of performing a data transfer via a bus from a buffer memory, in which data sequentially captured from a data supply apparatus is temporarily stored, to a memory accessed by at least one memory access circuit via the bus, wherein
the data transfer is performed under a state where the bus is occupied from when an amount of data in the buffer memory exceeds a first predetermined amount to when the amount of data in the buffer memory is less than a second predetermined amount smaller than the first predetermined amount.
